(19) United States
(12) Patent Application Publication
(10) Pub. No.: US 2010/0015028 A1
(43) Pub. Date: Jan. 21, 2010

(54) PURIFICATION METHOD

(76) Inventors: Daniel Johnson, London (GB); Jonathan Tudor, London (GB); Anthony William Kynaston-Pearson, London (GB); Alastair Bryan Godfrey, London (GB)

Correspondence Address: NIXON & VANDERHYE, PC, 901 NORTH GLEBE ROAD, 11TH FLOOR, ARLINGTON, VA, 22203, US

(21) Appl. No.: 12/515,626

(22) PCT Filed: Nov. 22, 2007
(86) PCT No.: PCT/GB07/04478

§ 371 Date: Sep. 29, 2009

(30) Foreign Application Priority Data
Nov. 22, 2006 (GB) 0623290.4

(51) Int. Cl. C01B 33/037

(52) U.S. Cl. 423/349; 977/773

(57) ABSTRACT

A method for removing one or more substances from a starting material comprising a metal, a semi-metal, a metal compound or a semi-metal compound comprises the steps of mixing fine particles of said starting material with a reagent Y and heating the starting material so as to effect a diffucion interface between the starting material and the reagent Y such that the one or more substances migrate from the nanoparticle to reagent Y. Purified metal or semi-metal particles are thereby produced. The method can be used for the production of photovoltaic grade silicon.

The present invention relates to a process for removing one or more substances from a starting material comprising a metal, semi-metal, metal compound or semi-metal compound, by means of a chemical reagent, wherein said starting material is in the form of fine particles and preferably nanoparticles. More especially, the invention relates to the production of high purity silicon from nanoparticles of silica, silicates and/or metallurgical grade silicon.

Silicon is used widely in the electronics industry, for example in the production of semiconductors, integrated circuits and photovoltaic cells (also known as solar cells). In general, high levels of purity are required, the precise purity level depending upon the ultimate application. Typically, the purity of photovoltaic grade silicon (at least 99.9999%) is lower than electronic grade silicon (>99.9999999%) and critical impurities requiring removal include the first row transition elements such as V, Cr, Fe, Co, Mn, Ni and Ti, as well as Al, B, P, Zr, Nb, Mo, Ta, W and O. Inclusion of the afore-mentioned impurities has a serious detrimental effect on the performance of silicon-based devices, including solar cells, where the conversion efficiency of light to electricity is reduced.

Silicon is produced industrially by a two stage process. In the first stage, quartz is thermally reduced to low cost, metallurgical grade silicon having a typical purity of only 99.5 to 99.9%. In the second stage, the metallurgical grade silicon is further purified, usually by the Siemens process. In the Siemens process, the metallurgical grade silicon is first converted to a chorosilane, and then heated to deposit a higher purity silicon. This second, purification stage adds considerably to the cost of the final silicon product, as do further processing stages which may also be required to incorporate dopants into semiconductor grade silicon.

At present, there is no specific production process for intermediate grade, photovoltaic silicon, so solar cells are produced from expensive feedstock silicon. The availability of moderately pure silicon for solar cell fabrication is a highly desirable objective and hence, the market in solar cells is waiting to exploit high volumes of photovoltaic grade silicon made by an alternative, lower cost process.

Accordingly, a first aspect of the present invention provides a method for removing one or more substances from a starting material comprising a metal, a semi-metal, a metal compound or a semi-metal compound, said method comprising the steps of mixing fine particles of said starting material with a reagent Y and heating the starting material so as to effect a diffusion interface between the starting material and the reagent Y such that the one or more substances migrate from the starting material to reagent Y, thereby producing purer metal or semi-metal particles.

By fine particles is meant particles having a size in the order of 100 microns or less. Preferably the fine particles are nanoparticles by nanoparticles is meant particles having nanometric dimensions, and nanoparticles may have, for example, dimensions in the order of a few nanometres to several hundred nanometres. Nanoparticles may be spherical or aspherical, and may also be known as a nanopowder or as a nanometric material. The metal or semi-metal particles used as a starting material in the present invention include particles of metal and/or semi-metal alloys.

By semi-metal is meant a chemical element which is intermediate in properties between metals and non-metals, including B, Si, Ge, As, Sb and Te. These elements are sometimes also known as metalloids.

Preferably, reagent Y is selected from a gettering agent, a reducing agent or a combination thereof. In certain cases, reagent Y may act both as a gettering agent and a reducing agent.

In a particularly preferred embodiment of the invention, the starting material comprises a metal or semi-metal, preferably a semi-metal selected from the group consisting of B, Si, Ge, As, Sb and Te, more preferably silicon and even more preferably metallurgical grade silicon (MG-Si). In any of the afore-mentioned cases, the one or more substances to be removed comprises residual metallic and/or non-metallic impurities within said metal or semi-metal and the product of the process is a metal or semi-metal having a higher degree of purity than the starting material.

In another preferred embodiment of the invention, the starting material comprises a compound of the metal or semi-metal, such as, for example, an oxide, nitride or sulphide. More preferably, the starting material is a compound of a semi-metal selected from the group consisting of B, Si, Ge, As, Sb and Te, and even more preferably the starting material is a silicon compound. Silica is one of the most abundant minerals on earth and is therefore a highly desirable starting material for silicon fabrication. Thus, for silicon fabrication, the starting material preferably comprises silica, but may alternatively comprise a silicate.

In the above case, the one or more substances to be removed includes the co-bonded element (i.e. oxygen for an oxide, nitrogen for a nitride, sulphur for a sulphide etc) as well as residual metallic and/or non-metallic impurities.

In either of the above embodiments, removal of the one or more substances from the starting material is brought about by using a chemical reagent Y, which reagent is in contact with or coated onto particles of the starting material and can take a solid form. Upon heating the contacted particles, the one or more substances migrate from the starting material to reagent Y, by a combination of physical and chemical processes, and the resulting product comprises purified metal or semi-metal particles contacted or coated with reagent Y and by-products containing the one or more substances. Reagent Y and by-products can then be removed in a further step, thereby producing a pure powder product. Possible methods of removing reagent Y will be well known to the skilled person and include aqueous dissolution and acid etching.

The present invention enables a purified metal or semi-metal to be produced either from a less pure metal or semi-metal starting material, or directly from a metal or semi-metal compound. In the specific case of silicon, photovoltaic grade silicon can be produced directly from metallurgical grade silicon, thereby circumventing costly prior art processes. Alternatively, the method of the invention allows silicon to be produced from a variety of other starting materials, such as, for example, silicon having a purity other than metallurgical grade, silica, silicates and other silicon-containing compounds. Of course, the degree of purification need not be limited to photovoltaic grade silicon and the process can be manipulated so as to purify silicon and/or silicon-containing compounds to electronic grade silicon or intermediate purity levels.

In general, purification processes can proceed by a number of different mechanisms, examples being recrystallisation, chemical reaction and diffusion. The present inventors have realised that, by using a starting material in the form of fine particles, purification can proceed by a number of different routes simultaneously, namely classical diffusion of impurities from areas of high concentration to areas of lower concentration, gettering of crystal defects and impurities associated therewith to the nanoparticle's surface and, in the case of a metal or semi-metal compound, reduction to the metal or semi-metal. All of the afore-mentioned processes proceed more rapidly and efficiently where diffusion distances are short and the surface area is large. Thus, the invention is able to take advantage of a fine powder's inherent physical properties (small particle size and large surface area), leading to a lower cost and more efficient method than the prior art.

Another benefit of the present invention is that the product is in the form of a powder, which powder can be further processed by any suitable powder processing techniques (e.g. casting). Moreover, because the product is in a purified form prior to casting, the need for post-casting purification steps is ameliorated.

If the starting material is a metal or semi-metal compound, it may be desirable to conduct the purification process in two stages, each stage individually involving the method of the present invention. For example, it may be advantageous to reduce the compound to a metal or semi-metal having an intermediate purity in a first stage, remove reagent Y, add more reagent Y and then further purify the metal or semi-metal produced by the first stage. Reagent Y may comprise different materials at each stage, for example a first reagent Y may be specially selected for its reducing properties and a second reagent Y may be specially selected for its gettering properties. It may also be necessary to replace a contaminated first reagent Y with clean reagent Y, so as to achieve the desired purity level in the final product.

In some instances, it may be necessary to pre-process the starting material to obtain a suitable starting purity level. In the particular case of reducing silica to silicon, it may be preferable to include a pre-purification step whereby crude silica ore is first converted to a water soluble silicate (e.g. sodium silicate) or silicic acid and then subjected to water treatment processes such as ultra-filtration or ion-exchange. The purified silicate or silica can then be deposited from solution by known methods and subjected to the method of the invention.

As stated above, the purpose of reagent Y is to remove one or more substances from the starting material. If the starting material substantially comprises a metal compound or semi-metal compound MX, the one or more substances to be removed includes X and may also include residual metallic and/or non-metallic impurities. Thus, the process is a combined extraction and purification process and reagent Y is required to function both as a reducing agent for compound MX and as a gettering agent for impurities. If, on the other hand, the starting material substantially comprises a metal or semi-metal, the one or more compounds substantially comprise the above-mentioned residual impurities and reagent Y acts primarily as a gettering agent. In either case, X and/or the residual impurities diffuse out from the individual nanoparticles towards reagent Y and may be retained within the contacting of interface/coating layer and/or released as an evolved gas.

Examples of residual impurities include the first row transition elements such as V, Cr, Fe, Co, Mn, Ni and Ti, as well as Al, B, P, Zr, Nb, Mo, Ta, W and O. Typically X comprises O, N or S.

Preferably, reagent Y is in intimate contact with the nanoparticles of the starting material. This may be in the form of nanoparticles in contact with a gas or liquid or possibly as discrete nanoparticles of Y coated onto the surface of the starting material, but more preferably as a continuous coating, i.e. a shell of reagent Y coated onto the surface of individual nanoparticles. Any suitable contacting or coating method may be used, such as powder mixing, vapour deposition or melt deposition fluidised beds, sols or gels. For some solid forms of reagent Y. The required coating depth depends on the application, but typically lies in the range monatomic, or 0.1 to 10 nm, more preferably 1 to 5 nm.

The amount of reagent Y used in the process depends on the precise application, i.e. whether reagent Y is acting primarily as a gettering agent for residual impurities, or whether reagent Y is also required to reduce a metal or semi-metal compound. In the former case, reagent Y is typically present at 1-2 wt %. In the latter case, reagent Y needs to be present in an amount dictated by the stoichiometry of the reduction reaction taking place, and preferably in a slight excess.

A gettering agent is a material which is added in small amounts during a chemical or metallurgical process to absorb impurities. Gettering agents are commonly metals which are more electropositive than the impurities to be removed, but are not exclusively so. In the semiconductor industry, gettering agents such as aluminium are used to remove impurities from bulk silicon wafers by coating one surface of said wafer with the agent. Typically, the coated surface remains an integral part of the silicon wafer and may even act as part of the semiconductor device. Similarly, in the photovoltaic industry, aluminium is sometimes incorporated into the metallisation layers of the photovoltaic cell, the metal combination being annealed to getter oxygen and other impurities out of the semiconductor material. This improves carrier lifetime and cell efficiency.

In the present invention, the gettering agent may be selected from known gettering materials such as aluminium, magnesium, zinc, carbon, sodium, calcium, lithium, potassium, hydrogen, sucrose or sodium chloride or a combination thereof, but, in contrast to use in the electronics industry, the gettering agent is preferably removed from the purified nanoparticles in a further processing step, thereby producing a pure metal or semi-metal powder for casting etc.

The nanoparticles are heated in order to increase the rate of the various purification processes taking place in the starting material. The preferred process temperature depends on the precise purification process taking place, but, for best results, the temperature typically lies in the range 600 to 1700° C., more preferably 800 to 1200° C. Advantageously, the heating step is carried out in an inert atmosphere so as to prevent side-reactions. The nanoparticles are heated for a length of time sufficient for migration of the one or more substances to take place and the nanoparticles to reach the desired purity level.

The nanoparticles of the starting material may be produced by any suitable method. Examples are ball-milling, deposition from a sol-gel or plasma deposition. Preferably, the nanoparticles are produced by a plasma-based method and more preferably by a plasma-spray method. Plasma techniques are preferred because firstly, they are particularly suitable for forming nanoparticles having the desired physical properties and secondly, the plasma apparatus can be used to co-deposit reagent Y during nanoparticle synthesis, either within the plasma region itself or during the quenching stage.

The nanoparticles are preferably as small as possible so as to maximise surface area and minimise diffusion distances, thereby optimising the reaction time and efficiency. Advantageously, the nanoparticles lie in the size range 1 to 200 nm, more preferably in the range 5 to 100 nm and even more preferably in the range 10 to 50 nm.

In a second aspect of the present invention there is provided a method of purifying a metal or a semi-metal comprising the steps of mixing metal or semi-metal nanoparticles with a gettering agent and heating the nanoparticles so as to effect a diffusion interface between the starting material and the gettering agent such that residual impurities migrate from the nanoparticle to the gettering agent.

In a third aspect of the present invention there is provided a method of producing a metal or semi-metal M from a metal compound or semi-metal compound MX comprising the steps of mixing fine particles of the metal or semi-metal compound with a reducing agent and heating them so as to effect a diffusion interface between the particles and the reducing agent such that X migrates to the reducing agent and the metal or semi-metal M is produced.

In a fourth aspect of the present invention, there is provided a method of producing photovoltaic grade silicon, said method comprising the steps of mixing fine particles of metallurgical grade silicon with a gettering agent and heating the fine particles so as to effect a diffusion interface-between the fine particles and the gettering agent such that impurities migrate from the silicon nanoparticles to the gettering agent. Preferably, reagent Y is removed in a further processing step so as to produce purified silicon powder.

An aspect of the invention, provides the purification or de-oxidation process may be achieved involving a reaction on a solid particle of the starting material to be purified and reagent Y in a fluid phase, including liquid, gaseous or plasma state.

It can be readily seen that both the second and third means above relate to the same reactions as described for the first means, as hereinbefore described. In all the above means and aspects the use of a high temperature plasma is preferred.

Consequently it may be readily understood that in such a reaction in the presence of high temperatures and rapid changes between the 4 states of matter there will be reactions occurring that accord with all the three means herein described. Indeed the proportion of material yielded by said reaction which is due to each means described may vary with the physical and chemical parameters of the starting material and of reagent Y.

Specific embodiments of the present invention will now be described with reference to the accompanying drawings, in which:

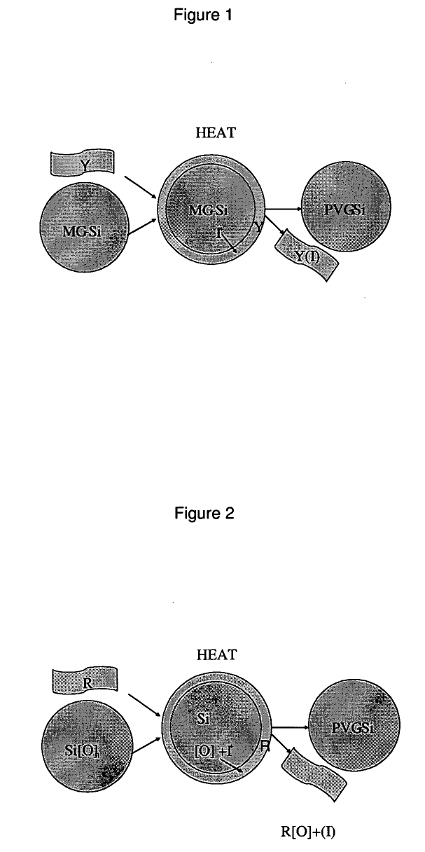

FIG. 1 is a schematic representation of the production of photovoltaic grade silicon from metallurgical grade silicon according to the invention;

FIG. 2 is a schematic representation of the production of photovoltaic grade silicon from silica or a silicate according to the invention; and

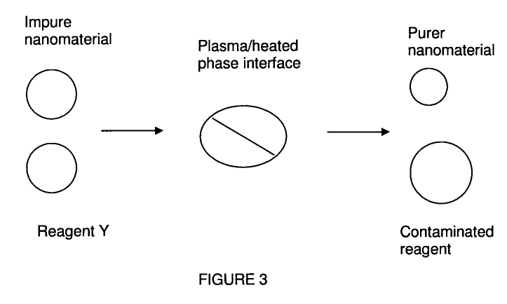

FIG. 3 is a further schematic representation of particles undergoing the purification process according to the invention.

FIG. 1 is a schematic representation of the production of photovoltaic grade silicon from metallurgical grade silicon. In the process, a nanoparticle of metallurgical grade silicon MG-Si is placed in contact with or coated with a gettering agent Y and then heated such that impurities I⁺ migrate to the gettering agent Y. After the nanoparticle has been heated for a suitable duration, the contaminated interface comprises gettering agent and impurities Y(I) is removed from the nanoparticle, leaving behind photovoltaic grade silicon PVG-Si as the reaction product.

FIG. 2 is a schematic representation of the production of photovoltaic grade silicon from silica or a silicate. In the process, a silica or silicate nanoparticle Si[O]ₙ is first placed in contact/coated with a reducing agent R and the coated nanoparticle is then heated such that impurities I⁺ and oxygen [O] migrate to the reducing agent R. After the nanoparticle has been heated for a suitable duration, the contaminated interface comprising reducing agent and impurities R[O]+(I) is removed from the nanoparticle, leaving behind photovoltaic grade silicon PVG-Si as the reaction product.

Referring to FIG. 3 there is shown a schematic diagram of a reaction process using a plasma reaction phase in which mixed starting materials are ionised and heated in a plasma device. In one example impure silica is powdered into a nanoparticle form and mixed with flaked aluminium which will act as reducing agent. The powder blend is vapourised in a plasma generator to a temperature in excess of 2000 C and possibly as high as 10,000 C. The reactants are held in this form for at least several seconds (and possibly as long as one or two minutes) and the temperature reduced to an ambient temperature to allow the reactants to condense back to solid. The reactants are reheated to about 800 C for a further hour before again cooling further. Then using an acid etch to remove the contaminated reagent thereby leaving a purer form of silicon which can then be washed ready for further use.

Some more specific examples will now be given wherein the materials used are as follows.

Samples of fumed silica from Degussa (aerosol R974) and a second sample supplied by Alfa Aesar are used in the examples below. Samples of Sodium Silicate were derived from a solution of sodium silicate (water glass) supplied by BDH and having a SiO2 assay of 25.5-28.5% and Na2O of 7.5% to 8.5%. Metallic impurities were in the order of 0.01% comprising 0.005% iron alone. It was found using ICPMS analysis that subjecting this solution, or one with reduced pH with HCl, to mixing for one hour with a WAC (weak anionic complex) ion exchange resin, Amberlite IRC-86, resulted in significant reduction of impurity levels, thus taking the feedstock silicate from nominally 99.99% purity to one of 99.9999% purity. The resulting solution was dried out at 200° C. and milled into a coarse powder. Alternatively, a second solution was spray dried into a fine powder of ˜100 microns size without the need for milling.

These samples were then subjected to reaction to cause a chemical reduction with the samples remaining in the solid state in finely divided form to allow advantageous mixing with other reagents and a high surface area for reaction.

### EXAMPLE 1

The reaction stoichiometry means that 5 grams of silica (0.0833 moles) requires 1.25 mole equivalent or 2.81 g of aluminium. In fact 2.6 grams of aluminium was used as the fine flake material and mixed thoroughly with the silica by shaking in a stoppered glass vessel. The mixed powder took on a light grey appearance apart from small lumps of agglomerated silica. The mixed powder was added to quartz crucible and heated in a nitrogen atmosphere in a box furnace at a ramp rate of 50 C per minute. The reaction time was started when at the reaction temperature of 800° C. was reached.

After one hour the sample was cooled at ˜50° C. per minute to 100° C. under a nitrogen purge and removed from the crucible. The material was substantially blackened and particles were adhered together. Some of the silica remained as unreacted lumps from the agglomerate seen at the outset of reaction. Observations in an optical microscope showed there to be white grains of unreacted silica remaining in the mixture and black particles of silicon. Analysis using x-ray diffraction showed the presence of microcrystalline silicon in the mixture. Unreacted silica appeared to exist owing to absence of an intimate contact forming with aluminium flakes and its molten phase.

### EXAMPLE 2

A sample of the Degussa fumed silica and a second sample from Alfa Aesar were each added to a slight excess to aluminium metal flake and were each separately reduced to silicon over a period of one hour at 900° C. The same reaction product occurred as in example 1.

### EXAMPLE 3

Aluminium metal flake was added to each of the silica samples separately and heated for a period of one hour at 650° C. using the conditions of examples 1 and 2. The product appeared substantially unreacted, mostly comprising white silica powder and aluminium microspheres.

### EXAMPLE 4

A sample of the Degussa fumed silica and a second sample from Alfa Aesar were each added as a slight excess to surface oxide passivated aluminium nanoparticles produced by QinetiQ NanoMaterials Ltd, mixed as before and heated to 800° C. using the condition of example 1, 2 and 3.

The resulting powder was unreacted owing to a surface layer of oxide present on the nano powdered aluminium. The conclusion was that the reaction proceeds by intimate contact between molten aluminium and the silica particles.

### EXAMPLE 5

Coarsely milled sodium silicate sample was mixed by shaking together with aluminium flake in the molar ratio 1:1.25 respectively. The mixture was heated to 800° C. for one hour in nitrogen. The cooled sample had become blackened, with some remaining lump of white powder. The sample of sodium silicate that had been spray dried to a fine powder and subjected to reaction with aluminium flake at 800° C. was substantially blackened and there was no evidence of unreacted material. X ray diffraction on this powder showed it to substantially comprise microcrystalline silicon.

### EXAMPLE 6

Replacing aluminium with magnesium turnings provided a more effective reaction a 800° C. for 1 hour, even though mixing was poor with the magnesium ribbon and it surface was oxidised. The fact that magnesium above its melting point has substantially higher vapour pressure than aluminium enables the oxide layer to become circumvented and for vapour to provide a more effective mixing with the surrounding silica provided a purge gas prevented oxidation of the magnesium vapour and the gas did not flush out the vapour from the reaction environment. The reaction temperature occurred above 750° C., suggesting that the rate limiting step is caused by the rate of out diffusion of oxygen from the silica or silicate chemical species. Whilst reaction has been observed at 700° C. in the case of magnesium, for practical purposes the reaction appears to be optimised for temperature above 800° C.

The metal used in metallothermic reduction seemed to be dependent on the native reducing power of the metal and its ability to provide adequate contact with the particle to be chemically reduced or so called de-oxidation. Reaction rate was in accordance with increasing temperature.

The fact that silica remains below its melting temperature means that it reacts in the solid state and that the reaction is driven by interfacial contact area. Therefore adequate mixing is necessary for the reaction to be stoichiometric and to go to completion However, one advantage of the present method is that mixing and interfacial area of reagents is significantly improved over reactions in the molten or liquid states. With improved control, unwanted side reaction and secondary phases are prevented, for example formation of metal silicides to unreacted oxides in the examples cited for silicon. It was not possible to use zinc the undergo reaction with silica or silicate owing to the lower electronegativity of this metal with respect to reaction with oxides under conventional reaction conditions normally covering the range 1-2000° C. The reaction is limited to the redox potential of the reducing metal. However, should the reagent becomes one of silicon tetrachloride or other halogenated or hydrogenated reaction intermediates from silica or silicate, then it remains feasible to use metals such as zinc.

Thus, a reaction with reducing metal is possible to reduce silica or silicate chemical species in the temperature range 600 to 2000° C. or preferably in the range 800-1000° C. for a period of time from 1-1000 minutes, but preferably in the range 10 to 100 minutes.

For reactions conducted in plasma, such as exists in the plasma torch apparatus operated by QinetiQ Nanomaterials Ltd, herein described, reagent temperatures are raised to approximately 10,000° C. and are spontaneously vaporised and ionised Reactions are made possible through this conversion process such that reactive gettering with other reagents permits deoxidation or chemical reduction otherwise limited or unobtainable using conventional reaction conditions.

Therefore a reduction reaction scheme is described using a plasma deposition apparatus at QinetiQ NanoMaterials limited. The feedstock silica and silicate were fine powders with preparations hereinbefore described.

### EXAMPLE 7

A source of fumed silica from Alfa Aesar (silica flour) was passed into the plasma torch apparatus along with an amount of aluminium powder in the ratio described in example 1. The plasma torch apparatus produced a nano powdered product under an argon purge gas. This was heated for 1 hour at 800° C. to ensure reaction had gone to completion. The product was removed and found to be blackened. The product in x-ray diffraction was found to be substantially silicon and alumina. The alumina was later removed by acid leaching.

The following further examples refer to the ability of fine particle matter to undergo out diffusion of impurity species into a second phase either comprising gas, or liquid or solid and that removal of said impurities into the second phase can either be by reactive capture of the impurity (gettering) or by processes governed by laws of diffusion. The term coating herein describes a second phase able to interact either as a reactive getter or diffusion sink to the fine particle matter. The objective is to purify the fine particle matter from its initially impure state. The fine particle may be any form of material, for example a chemical compound, element or alloy or any mixture of these.

### EXAMPLE 8

A source of metallurgical grade silicon powder (MGSi) at 99.9% purity and-325 mesh was supplied by Sigma-Aldrich. It was mixed in a 1:1 mass ratio with a passivated aluminium nanopowder supplied by QinetiQ Nanomaterials Ltd. The mixture was heated treated in a nitrogen purged steel crucible for 5 hours at 800° C. The impurities in the silicon did not seem to alter.

### EXAMPLE 9

As a further example, a sample of the same silicon powder as in Example 8 was mixed with magnesium ribbon and heated to the same temperature for the same time.

SIMS analysis was conducted on both heat treated silicon samples and compared to as supplied powder. Metallic impurities and oxygen were found to be depleted in the first 50 nm of the particle surface, but increased back to levels found uniformly in the as supplied sample. The dip in impurity profile in the surface layers was approximately two orders of magnitude.

Example 8 used MG-Si powder which has a large particle size. The reaction with nano aluminium did not take place because the aluminium had a passivated surface and the oxide acted as a diffusion barrier, hence no out diffusion from the silicon is observed The use of magnesium however in example 9 allowed the metal to directly contact the surface of the MGSI powder. The reason for this is that magnesium has a high vapour pressure above its melting point so it readily coats silicon particle surfaces with bare metal—hence acts as a gettering agent. However, owing to the size of the silicon particles, it was unable to remove impurities from deeper levels within the particles because of the longer diffusion length from the inner parts. This would not be true for smaller particles e.g. nanoparticles, where diffusion lengths are shorter and diffusion more complete.

### EXAMPLE 10

A sample of nano powdered silicon of average particle size 30 nm diameter was mixed with one of nano powdered aluminium with the same average particle size and heated at 850° C. for 1 hour. XPS and SIMS analyses showed no reduction in oxygen concentration on the particle surface or reduction in the level of metallic impurities uniformly throughout the particles. It is believed that the passivation layer on the aluminium acted as a diffusion barrier.

It is the case that no reaction was seen in example 10, even though nano silicon was employed compared to example 8 where larger particles were employed. Again it is thought that reaction was inhibited by the aluminium particle surface having an oxide layer (passivated) and thus a diffusion barrier was present. However, example 10 did proceed because the aluminium and silicon nanopowders were produced in-situ in the plasma deposition rig and were able to interact because the aluminium was not passivated as the air exposed material (seen in example 8), so diffusion barriers were absent and gettering was possible.

It is apparent therefore that the reactant must enable an effective diffusion interface with starting particles thereby to act as diffusion sink for bulk diffusion of impurities from within particles of the starting material to the reactant. Accordingly, in some case materials are ineffective as a reactant since the interface created with particles of the starting material act as a diffusion barrier. Some materials may be better solid state diffusion media (eg metals) to impurities than others. Alumina is an example of material acting as a diffusion barrier, but other oxides might allow fast ionic diffusion.

### EXAMPLE 11

A sample of metallurgical grade silicon, MGSi from example 8 was finely divided and fed into the plasma torch apparatus at QinetiQ NanoMaterials Ltd along with aluminium flake in the mass ratio 10:1, silicon to aluminium. The resulting nano powdered product was annealed at 850° C. for 1 hour. XPS and SIMS particle analyses showed that metallic impurities had been removed from the silicon. In this example the passivating layer of oxygen on the aluminium, seen in example 12, was assumed to have been absent.

### EXAMPLE 12

A sample of untreated nano powdered silicon was mixed with a solution of purified sucrose, coated and then heated to dryness and the sugar decomposed to carbon by thermal decomposition. The mixture was heat treated to 850° C. for 2 hours. Isolated particles of nano powdered silicon were analysed using SIMS and found to be depleted at their surface of metallic impurities, presumably through out diffusion into the surrounding carbon.

### EXAMPLE 13

A sample of nano powdered silicon was mixed with a solution of purified sodium chloride and then heated to dryness and further heated to 850° C. in nitrogen at which point the sodium chloride became molten. After 1 hour, the material was cooled and the sodium chloride dissolved away to leave the silicon nanopowder. SIMS analysis showed that the silicon had become depleted of metallic impurities by two orders of magnitude, believed to be because of surface exchange of impurities into the bulk of the molten sodium chloride. Other inorganic or organic salts in a solid, molten or gaseous form of acidic neutral or alkaline pH will be able to work in the same way, provided that impurities are not able to diffuse from this pure phase into the nano powdered silicon, or other finely divided materials, and that impurities may diffuse out. A preferred term for this process would be high surface area impurity leaching of solids.

### EXAMPLE 14

A sample of nano powdered silicon was heated to 850° C. in hydrogen and after cooling the sample showed using XPS an increase in impurity level presumably through segregation from defects and onto the nanoparticle surfaces.

### EXAMPLE 15

A sample of nano powdered silicon was heated to 850° C. in nitrogen for 1 hour and after cooling showed no sign of impurity segregation to the nanoparticle surfaces.

The gettering or out-diffusion scheme described here has been found in various guises to be an effective method of removing impurities from a fine particle matter. The extent of diffusion appears to be controlled by the particle size of the particles in the fine particle matter, the purity of the second phase to act as a diffusion sink, the diffusivity of impurity species from the fine particle matter into the second phase and the temperature and time for the out-diffusion process.

Thus a process is suitable where interaction of a second phase of equivalent purity of one of higher purity is able to remove impurities by diffusion from fine particle matter in the size range 1-1000 nanometres, or preferably in the range 1-100 nm. The process may proceed efficiently using chemical reactions in the temperature range 1-2,000° C., but preferably in the range 500-1400° C. and for periods of 0.1-10000 minutes, but preferably in the range 1-60 minutes. Where the process is conducted within a plasma deposition apparatus, then the range of plasma temperature is suitably in the range 4,000 to 14,000° C. but preferably in the range 6,000 to 10,000° C.

The ratio of the fine particle matter to the second phase can be in the range 1:1 or 1000:1 by molar ratio, but preferably in the range 10:1 or 100:1 by molar ratio. It is preferable for practical purposes that the second phase is readily removed following the out-diffusion process with the fine particle matter, so that impurities may be carried away with the second phase without re-contaminating the fine particle matter once more.

The above embodiments are not to be regarded as limiting in that modifications to the above would be obvious to one skilled in the art. In particular, their teaching would be transferable to other elements of the periodic table and suitable means for heating the nanoparticles may be selected depending on the specific application. Moreover the use of the term mixing, contacting and coating are used here to describe the process of integrating starting materials sufficiently to enable the reaction phase of the purification step to take place. The reaction phase being understood to occur at high temperature and be a migration or diffusion process enabling contaminates in the nanoparticle starting material to migrate or otherwise diffuse to the reagent. Hence, a diffusion interface occurs between the nanoparticles and reagent during the reaction phase in the form of at least a partial contacting/coating of the nanoparticles by the reagent.

1.-30. (canceled)

31. A method for removing one or more substances from a starting material comprising a metal, a semi-metal, a metal compound or a semi-metal compound, said method comprising the steps of mixing fine nano-sized particles of said starting material with a reagent Y and heating the starting material so as to effect a diffusion interface between the starting material and the reagent Y such that the one or more substances migrate from the starting material to reagent Y, thereby producing purer metal or semi-metal particles.

32. A method according to claim 31 wherein the purer metal or semi-metal particles result from two or more of recrystallisation, chemical reaction and diffusion.

33. A method according to claims 31 wherein conditions are set to enable short particle diffusion distances for the substances are short and the surface area of the fine nano-sized particles is large.

34. A method according to claim 31, wherein reagent Y is selected from the group consisting of a gettering agent, a reducing agent, a leaching agent, a diffusion sink or a combination thereof.

35. A method according to claim 31, wherein reagent Y is in the form of a solid at room temperature, and preferably wherein the diffusion interface is effected at a reaction temperature at which wherein the reagent Y is no longer solid.

36. A method according to claim 31, wherein reagent Y is selected from the group consisting of aluminium, magnesium, zinc, carbon, sodium, calcium, lithium potassium sucrose, sodium chloride or hydrogen or a combination thereof.

37. A method according to claim 35, wherein the starting material is selected from the group consisting of silicon, silica, a silicate material, and wherein photovoltaic grade silicon is produced.

38. A method according to claim 35, wherein reagent Y is present in an amount ranging from 1 to 2 wt %; and/or wherein reagent Y is present in an amount dictated by the stoichiometry of the reduction reaction taking place.

39. A method according to claim 31, wherein the fine particles are nanoparticles having a size of 1 to 200 nm, prior to the coating step.

40. A method according to claim 31, wherein the nanoparticles are produced by a plasma technique.

41. A method according to claim 31, wherein reagent Y is co-fed with the starting material such that coated nanoparticles are produced.

42. A method according to claim 31, wherein reagent Y is in the form of nanoparticles.

43. A method according to claim 31, wherein the mixed fine particles and reagent are heated to a temperature in the range 600 to 1700° C.

44. A method according to claim 31 wherein a reaction temperature is maintained for between 1 and 1000 minutes.

45. A method according to claim 31, wherein the heating step is conducted in a substantially inert atmosphere.

46. A method according to claim 44 wherein the starting material and reagent are heated to between 4000 and 14000° C.

47. Metal or semi-metal particles produced by the method of claim 31.

48. A method claim 31 wherein the purified metal or semi-metal particles are further processed to remove reagent Y.

49. A method for removing one or more substances from a starting material comprising a metal, a semi-metal, a metal compound or a semi-metal compound, said method comprising the steps of mixing fine particles of said starting material with a reagent Y and heating the starting material so as to effect a diffusion interface between the starting material and the reagent Y such that the one or more substances migrate from the starting material to reagent Y, thereby producing purer metal or semi-metal particles, and wherein the purer metal or semi-metal particles result from two or more of recrystallisation, chemical reaction and diffusion.

50. A method for removing one or more substances from a starting material comprising a metal, a semi-metal, a metal compound or a semi-metal compound, said method comprising the steps of mixing fine particles of said starting material with a reagent Y and heating the starting material so as to effect a diffusion interface between the starting material and the reagent Y such that the one or more substances migrate from the starting material to reagent Y, thereby producing purer metal or semi-metal particles, and wherein conditions are set to enable short particle diffusion distances for the substances are short and the surface area of the fine nano-sized particles is large.

51. A method for removing one or more substances from a starting material comprising a metal, a semi-metal, a metal compound or a semi-metal compound, said method comprising the steps of mixing fine particles of said starting material with a reagent Y and heating the starting material so as to effect a diffusion interface between the starting material and the reagent Y such that the one or more substances migrate from the starting material to reagent Y, thereby producing purer metal or semi-metal particles, and wherein reagent Y is coated onto the fine particles to a depth of at least one atomic layer to 10 nm.
